(19) United States
(12) Patent Application Publication
(10) Pub. No.: US 2017/0073570 A1
(43) Pub. Date: Mar. 16, 2017

(54) DEVICE FOR PRESSING IN CELLULOSE FIBER NANO-DISPERSION, METHOD FOR PRESSING IN CELLULOSE FIBER NANO-DISPERSION USING SAME, AND HYDROCARBON PRODUCTION METHOD

(71) Applicant: DAI-ICHI KOGYO SEIYAKU CO., LTD., Kyoto-shi, Kyoto (JP)

(72) Inventors: Yosuke GOI, Kyoto (JP); Mineo SABI, Kyoto (JP); Kazuhito JINNO, Kyoto (JP); Koji NODA, Kyoto (JP); Yoshitake KATO, Tokyo (JP); Norihiko TOGASHI, Tokyo (JP); Yosuke KUNISHI, Tokyo (JP)

(73) Assignee: DAI-ICHI KOGYO SEIYAKU CO., LTD., Kyoto-shi, Kyoto (JP)

(21) Appl. No.: 15/120,453

(22) PCT Filed: Nov. 25, 2014
(86) PCT No.: PCT/JP2014/081112

§ 371 Date: Aug. 19, 2016

(30) Foreign Application Priority Data
Mar. 3, 2014 (JP) 2014-040999
Mar. 3, 2014 (JP) 2014-041000
Mar. 3, 2014 (JP) 2014-041001

(51) Int. Cl. C09K 8/516; E21B 33/13; C09K 8/58

(52) U.S. Cl. CPC C09K 8/516; C09K 8/58; E21B 33/13; C09K 2208/08; C09K 2208/10

(57) ABSTRACT

A cellulose fiber nano-dispersion pressing-in device for pressing a liquid, in which a cellulose fiber of a conifer-derived pulp is nano-dispersed, into a stratum, includes a grinding means for grinding the conifer-derived pulp in water, a dilution means for diluting a cellulose fiber-containing liquid obtained in the grinding means and a pressing-in means for pressing a nano-dispersion of the cellulose fiber obtained in the dilution means into a well. Therefore, it is applicable to water-stopping operation in a civil engineering process or to a process of industrial production of hydrocarbons such as crude oil, gas and the like for improving the recovery rate thereof.

### TECHNICAL FIELD

The present invention relates to a cellulose fiber nano-dispersion pressing-in device mainly applicable to a process of industrial production of hydrocarbons such as crude oil, gas, etc. or to water-stopping operation in a civil engineering process, to a cellulose fiber nano-dispersion pressing-in method using the device, and to a hydrocarbon producing method.

### BACKGROUND ART

In crude oil recovery, gas recovery operation or civil engineering operation, a great deal of groundwater discharge from wells often becomes a problem. Specifically, for example, in recovery of crude oil, gas and the like retained in an oil reservoir, accompanying water may be produced along with hydrocarbons, but the accompanying water contains large quantities of crude oil components in the form of an emulsion and further contains various kinds of organic acids, heavy metal ions and the like, and accordingly the treatment for these requires an enormous expense. In particular, in oil fields where secondary recovery and tertiary recovery of crude oil is needed after time passage from the start of production of hydrocarbons, a large amount of accompanying water is produced via the high-penetration zone in the oil reservoir, for which, therefore, the treatment provides a severe problem.

Here, for the purpose of preventing the generation of groundwater, various methods of blocking groundwater passages by the use of a gel are investigated. As one example thereof, for example, there is mentioned a method of using a hydrating gel prepared by adding a gelling agent containing a hexavalent chromium-containing compound and a reducing agent therefor to a copolymer solution of an acrylamide and a sulfonate salt-containing monomer, or a multi-component copolymer of an acrylamide, a sulfonate salt-containing monomer and a carboxylate salt-containing monomer (PTL 1).

On the other hand, in a method of secondary recovery of crude oil, for increasing the total weight of the crude oil to be recovered from the oil reservoir, use of a gellable composition is investigated for the purpose of reducing the penetration rate of a flowing-in fluid in the high-penetration zone in the oil reservoir in a rock ground to thereby increase the crude oil recovery rate from the low-penetration zone therein, and as the composition, there is known use of a composition containing a natural polymer such as xanthan gum, carboxymethyl cellulose or the like, or a water-soluble polymer such as polyacrylamide or the like, and an ion-crosslinking agent or the like (PTL 2).

In addition, a method of reducing the penetration rate of a flowing-in fluid in the high-penetration zone in the oil reservoir in a rock ground by crosslinking bacteria-derived cellulose nanocrystals with guar gum is investigated (PTL 3).

### CITATION LIST

### Patent Literature

PTL 1: JP-B 1-12538
PTL 2: JP-A 2-272191
PTL 3: WO2013/154926

### SUMMARY OF INVENTION

### Technical Problem

However, the gel composition proposed by PTL 1 is problematic in that the polyacrylamide of a synthetic polymer and chromium contained in the crosslinking agent may remain in the ground or may flow out into groundwater, and hence there has a high environmental load and may pose a health hazard to neighboring residents. In addition, mixing the polymer solution and the metal ion crosslinking agent promotes crosslinking reaction, and therefore, the polymer solution and the metal ion crosslinking agent must be injected separately, and therefore there still remains a concern on the reliability of curing in the area except the interface and therearound between the polymer solution part and the crosslinking part. In turn, a countermeasure such as microcapsulating the metal ion crosslinking agent so as to release the metal ion crosslinking agent after a lapse of a predetermined period of time in the underground is investigated. However, this is not versatile since preparation of microcapsules is complicated as they are applied to diversified underground environments including pH, temperature, pressure and the like.

On the other hand, xanthan gum used in the gel composition in PTL 2 is a microorganisms-derived biopolymer and therefore has a small environmental load, but chromium and boron contained in the crosslinking agent therefor can provide a problem in point of environmental load. In addition, the biopolymer of the type may be biodegraded before gelled in the underground area where various microorganisms exist, and therefore there is a risk that a sufficient water-stopping effect could not be realized. Naturally, the technique disclosed in PTL 2 is not for attaining a water-stopping effect.

On the other hand, one prepared by crosslinking bacteria-derived cellulose nanocrystals with guar gum in PTL 3 has a problem in that it could not realize a sufficient water-stopping effect in a site where the ground heat is high such as, in particular, an oil field since guar gum therein decomposes at a high temperature. The gel compositions described in PTL 1, PTL 2 and PTL 3 are viscous liquids, not losing flowability, and are therefore problematic in that they still have a certain level of flowability even after gelled.

Specifically, the above-proposed gel compositions would, when injected into underground wells, often undergo viscosity degradation owing to influences of ground heat (120° C. or higher) thereon and further owing to influences of mechanical shear by pumps, drills or the like thereon, and therefore there is a risk that, when they are thereafter gelled, their water-stopping effect may tend to be thereby adversely affected. Further, the biopolymer as exemplified in the above is a biogenic one, and a possibility that it may introduce some unintentional foreign microbes brought in from other regions to the underground could not be denied.

In secondary recovery of crude oil, there may be employed a method where water produced and separated in primary recovery or the like is again pressed into a well and the crude oil remaining in the oil reservoir is recovered, but owing to the difference in penetration rate in the oil reservoir or owing to the difference in specific gravity between a pressed-in fluid and an oil reservoir fluid, the sweep area may be located unevenly, and therefore there often is still much room for improvement in point of improving the crude oil recovery rate.

The present invention has been made in consideration of the situation as above, and its object is to provide a cellulose fiber nano-dispersion pressing-in device applicable to water-stopping operation in a civil engineering process or to a process of industrial production of hydrocarbons such as crude oil, gas and the like for improving the recovery rate thereof, to provide a cellulose fiber nano-dispersion pressing-in method using the device, and to provide a hydrocarbon producing method.

### Solution to Problem

For attaining the above-mentioned object, the first aspect of the present invention is a cellulose fiber nano-dispersion pressing-in device for pressing a liquid containing a cellulose fiber of a conifer-derived pulp being nano-dispersed therein, into a stratum, including a grinding means for grinding the conifer-derived pulp in water, a dilution means for diluting a cellulose fiber-containing liquid obtained in the grinding means and a pressing-in means for pressing a nano-dispersion of the cellulose fiber obtained in the dilution means into a well.

The second aspect of the present invention is a cellulose fiber nano-dispersion pressing-in method, including using the cellulose fiber nano-dispersion pressing-in device of the first aspect to thereby press a nano-dispersion of a cellulose fiber into an underground pervious stratum around a well.

The third aspect of the present invention is a hydrocarbon production method preferably using the cellulose fiber nano-dispersion pressing-in device of the first aspect, including a cellulose fiber nano-dispersion pressing-in step of pressing a cellulose fiber nano-dispersion prepared by grinding a conifer-derived pulp in water and dispersing it in a liquid, into an underground pervious stratum through a well.

Specifically, the present inventors have assiduously studied for the purpose of solving the above-mentioned problems. As a result, they have hit on a finding that, by using a cellulose fiber nano-dispersion pressing-in device including a grinding means for grinding a conifer-derived pulp in water, a dilution means for diluting a cellulose fiber-containing liquid obtained in the grinding means and a pressing-in means for pressing a nano-dispersion of the cellulose fiber obtained in the dilution means into a well, a stable water-stopping operation can be attained without giving any load to the environment, and have achieved the present invention. In particular, the present inventors have hit on a finding that, in a process of industrial production of hydrocarbons such as crude oil, gas and the like, when a dispersion in which a coniferous pulp-derived cellulose fiber is nano-dispersed is pressed into the underground pervious stratum through a well, by using the above-mentioned cellulose fiber nano-dispersion pressing-in device, then the water-producing site in the oil reservoir around the well and the high-penetration zone in the oil reservoir in a rock ground (prevailing flow channel) can be blocked up by the gel, and therefore a stable water-stopping effect can be realized without giving any load to the environment, and the hydrocarbon recovery rate from the well can be thereby increased.

### Advantageous Effects of Invention

The cellulose fiber nano-dispersion pressing-in device of the present invention includes a grinding means for grinding a conifer-derived pulp in water, a dilution means for diluting a cellulose fiber-containing liquid obtained in the grinding means and a pressing-in means for pressing a nano-dispersion of the cellulose fiber obtained in the dilution means into a well, and this can attain a stable water-stopping operation without giving any load to the environment. In particular, in the case where the grinding means is provided in the vicinity of the well in the earth's surface, the cellulose fiber nano-dispersion to be pressed into the well can be prepared at drilling sites, and can be directly pressed into the well. This can therefore solve problems of contamination of wells with microorganisms, time degradation of the cellulose fiber nano-dispersion and the like.

According to the hydrocarbon production method of the present invention, the coniferous pulp-derived cellulose fibers used as a gelling agent form a non-flowing gel when crosslinked with a crosslinking agent or under heat, and owing to the characteristics thereof, they can block up the water-producing site in the oil reservoir around wells and the high-penetration zone in the oil reservoir in a rock ground (prevailing flow channel), and therefore can improve the recovery rate of hydrocarbons such as crude oil, gas, etc. In particular, in the hydrocarbon production method, when a crosslinking agent is not used and the cellulose fibers are gelled by utilizing the ground heat, the crosslinking reaction does not go on before the cellulose fiber nano-dispersion reaches the pervious stratum around wells and, in addition, it is unnecessary to separately inject a crosslinking agent. Accordingly, various problems to be caused by a crosslinking agent (environmental problem, cost, injection operation, crosslinking control operation, etc.) could also be solved.

In addition, even in the case where a crosslinking agent is used in the hydrocarbon production method, when cellulose fibers of conifer-derived pulp that are chemically modified at the hydroxyl groups on the surfaces of the fibers are used and when a polyvalent metal salt is used as the crosslinking agent, both the cellulose fibers and the polyvalent metal salt have a low environmental load and further strong crosslinking can be formed starting from the chemically-modified parts, and consequently, even though a small amount is incorporated, a sufficient water-stopping effect can be realized and the hydrocarbon recovery rate from wells can be more effectively increased.

The cellulose fiber nano-dispersion pressing-in device of the present invention can also be used in a liquid hydrocarbon enhanced recovery method (EOR) of improving the liquid hydrocarbon recovery rate by using the cellulose fibers of the conifer-derived pulp as a so-called thickener without using a crosslinking agent, and pressing in the nano-dispersion of the cellulose fibers through a well and accordingly, extruding out the liquid hydrocarbon in the oil reservoir targeted by the well into another well that is connected via the oil reservoir, like in a polymer flood process.

### BRIEF DESCRIPTION OF DRAWINGS

FIG. 1 This is an explanatory view illustrating one example of the hydrocarbon production method of the present invention.

FIG. 2 This is an explanatory view illustrating another example of the hydrocarbon production method of the present invention.

FIG. 3 This is a sample picture indicating the characteristics of a sample used in the gelation determination method in Examples.

### DESCRIPTION OF EMBODIMENTS

Embodiments of the present invention are described in detail hereinunder.

The cellulose fiber nano-dispersion pressing-in device of the present invention includes, as described above, a grinding means for grinding a conifer-derived pulp in water, a dilution means for diluting a cellulose fiber-containing liquid obtained in the grinding means and a pressing-in means for pressing a nano-dispersion of the cellulose fiber obtained in the dilution means into a well. In the present invention, the “nano-dispersion” means dispersing the above-mentioned cellulose fibers on a nano-level, so that the maximum fiber diameter of the cellulose fibers is 1000 nm or less, preferably 500 nm or less, as determined according to the measurement method to be mentioned hereinunder. Accordingly, the grinding means requires a performance such that conifer-derived pulp can be ground on a nano-level as mentioned above. The above means may be integrated as the device, or may be divided into individual units so far as the units for the individual means may be organically associated with each other.

In particular, the grinding means is to grind conifer-derived pulp in water, and therefore the cellulose-containing liquid obtained in the grinding means contains a large amount of water. Accordingly, in consideration of transportation costs and others, it is preferable that the grinding means is provided in the vicinity of a well. The term “in the vicinity of a well” has nearly the same meaning as so-called “on-site”, and means arranging in an oil/gas production plant and transporting to each borehole well through a pipeline or the like. Preferably, the grinding means is arranged in the vicinity of a well in the earth's surface, since the cellulose fiber nano-dispersion to be pressed into the well can be prepared at the drilling sites and can be directly pressed into the well, and accordingly, one sterilized in nano-dispersing can be directly pressed into the well and problems of contamination of wells with microorganisms, time degradation of the cellulose fiber nano-dispersion and the like can be thereby solved.

Further, the pressing-in device is equipped with the dilution means for diluting the cellulose fiber-containing solution obtained in the grinding means, by gradually adding water thereto, and accordingly, stirring dispersion can be carried out in a more power-saving manner than in a case where the cellulose fiber-containing solution is directly diluted with a large amount of water, and the above-mentioned cellulose fiber nano-dispersion can be obtained efficiently.

The cellulose fiber nano-dispersion pressing-in method of the present invention uses the above-mentioned cellulose fiber nano-dispersion pressing-in device to press the nano-dispersion of cellulose fibers into the underground pervious stratum around wells, and accordingly, in civil engineering operation for wells, stable water-stopping operation can be carried out without giving any load to the environment.

The hydrocarbon production method of the present invention is carried out in a process of production of hydrocarbons such as crude oil, gas and others, and as described above, preferably uses the cellulose fiber nano-dispersion pressing-in device of the present invention. Specifically, the hydrocarbon production method of the present invention is carried out by pressing a cellulose fiber nano-dispersion prepared by grinding a conifer-derived pulp in water and by dispersing it in a liquid, into an underground pervious stratum through a well. Here, in the hydrocarbon production method, when a crosslinking agent is not used, and the cellulose fiber nano-dispersion is pressed into a well and thereafter the pressing-in flow channel is blocked up, followed by leaving as such for a predetermined period of time (about 24 hours or more), the cellulose fibers can be suitably gelled by the ground heat (about 120° C. or more). Therefore the resultant gel can block up the water-producing site in the oil reservoir around the well and the high-penetration zone in the oil reservoir in a rock ground (prevailing flow channel), and accordingly a stable water-stopping effect can be realized without giving any load to the environment, and the hydrocarbon recovery rate from the well can be thereby increased. Further, since a crosslinking agent is not used, the crosslinking reaction does not go on before the cellulose fiber nano-dispersion reaches the pervious stratum around the well and, in addition, it is unnecessary to separately inject a crosslinking agent, and accordingly, various problems to be caused by a crosslinking agent (environmental problem, cost, injection operation, crosslinking control operation, etc.) could also be solved. On the other hand, even in the case where a crosslinking agent is used, when cellulose fibers of conifer-derived pulp that are chemically modified at the hydroxyl groups on the surfaces of the fibers are used and when a polyvalent metal salt is used as the crosslinking agent, both the cellulose fibers and the polyvalent metal salt have a low environmental load and are therefore preferred from the viewpoint of environmental pollution, and moreover, strong crosslinking can be formed starting from the chemically-modified parts, and consequently, even though a small amount is incorporated, a sufficient water-stopping effect can be realized and the hydrocarbon recovery rate from wells can be more effectively increased.

In the hydrocarbon production method of the present invention, where a well (pressing-in well) into which the cellulose fiber nano-dispersion is to be pressed and a well (production well) through which hydrocarbons are recovered are the same well, the production amount of water from the oil reservoir in the well (accompanying water) reduces and, as a result, the hydrocarbon recovery rate can be increased. In turn, in the case where the pressing-in well and the production well are different wells, the prevailing flow channel for the pressing-in fluid can be blocked up by the gel of the cellulose fibers, and therefore the flow channel of the pressing-in fluid changes owing to further water and gas that may press in through the pressing-in well with the result that the hydrocarbons having remained in the oil reservoir could be expelled to the production well and the hydrocarbon recovery rate can be thereby improved.

After the cellulose fiber nano-dispersion pressing-in step as described above, there may be included a blocking step of blocking up a pressing-in flow channel thereof and a production step of recovering a hydrocarbon from the well after opening the blocking of the pressing-in flow channel. This is preferred as enabling a good gelation of the cellulose fibers to realize a good water-stopping effect, and accordingly, the hydrocarbon recovery rate from wells can be more effectively increased.

Before the cellulose fiber nano-dispersion pressing-in step and/or after the cellulose fiber nano-dispersion pressing-in step, there may be included a polyvalent metal salt-containing aqueous solution pressing-in step of pressing a polyvalent metal salt-containing aqueous solution into the well. This is preferred as enabling a good crosslinking at the site where a desired gel is to be formed to realize a good water-stopping effect, and accordingly, the hydrocarbon recovery rate from wells can be more effectively increased. Optionally, the cellulose fiber nano-dispersion may contain a polyvalent metal salt.

When, after the cellulose fiber nano-dispersion pressing-in step, an aqueous solution containing no cellulose fiber is pressed in and then the blocking step is carried out, the gelation of the cellulose fibers can be more readily attained at the site where the water-stop effect is desired, which is therefore preferred from the standpoint of more effectively increasing the hydrocarbon recovery rate.

When a clear water is pressed into the well before the cellulose fiber nano-dispersion pressing-in step, the salt ion concentration around the well in an oil reservoir can be lowered. Therefore, the problem can be solved such that the cellulose fiber nano-dispersion pressed in subsequently is gelled by metal ions in the ground (sodium ion, magnesium ion, etc.) before it could reach and spread in the water layer (high-permeation layer) side in the oil reservoir of the well and, as a result, the water layer side could not be well blocked off. In the present invention, the clear water means a water having a sodium ion concentration of less than 1% in terms of sodium chloride and a calcium ion concentration of less than 0.3% in terms of calcium chloride.

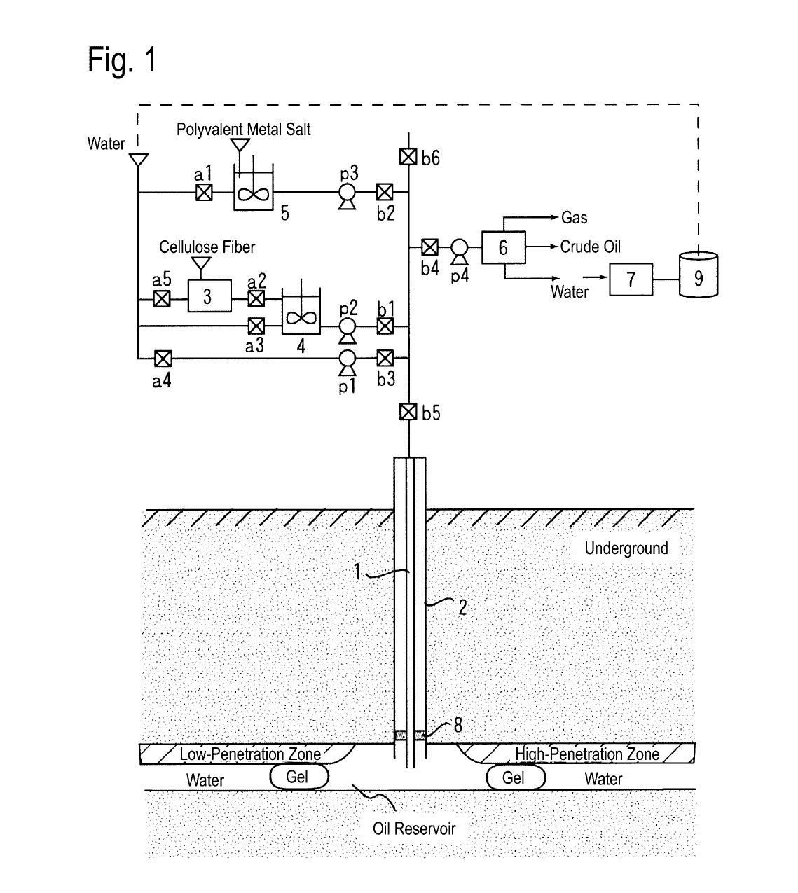

One example of the hydrocarbon production method of the present invention is described here with reference to FIG. 1. This example demonstrates a recovery method in which a well for pressing in (pressing-in well) and a well for hydrocarbon recovery (production well) are the same well, and by opening the well that has been blocked after the pressing-in, hydrocarbon is recovered from an oil reservoir. According to this recovery method, it is preferable from the viewpoint of the water-stopping effect that the cellulose fiber nano-dispersion is pressed into a well, and then an aqueous solution of a polyvalent metal salt is pressed into the well. In FIG. 1, a casing 2 and a tubing 1 are buried toward the underground oil reservoir, and between the casing 2 and the tubing 1, a packer (closing part) 8 is provided. A well generally has such a configuration, and after the first self-blowout of hydrocarbon, and further after the completion of hydrocarbon drawing by a pump (first recovery), the hydrocarbon production method using the cellulose fiber nano-dispersion pressing-in device of the present invention is applied. Generally in the hydrocarbon production method, first, valves a4, b3 and b5 are opened (while all the other valves are closed), clear water is injected into the well through the tubing 1 in the casing 2 by a pump p1 to thereby lower the salt ion concentration around the well in the oil reservoir. Next, the opened valves are closed, then the valve a5 is opened and conifer-derived pulp is ground in water by a high-pressure homogenizer 3 (e.g., STAR BURST manufactured by Sugino Machine Limited) or the like to thereby disperse the cellulose fibers under high pressure. Then the valves a2 and a3 are opened and optionally any other additives are added, and the cellulose fiber-containing liquid is diluted to prepare a nano-dispersion of the cellulose fibers by using a stirrer 4. Subsequently, the valves b1 and b5 are opened, and the cellulose fiber nano-dispersion is pressed into the well (into the pervious stratum around the well) by a pump p2, through the tubing 1 in the casing 2. Subsequently, the valve a1 is opened, and by a stirrer 5, a polyvalent metal salt-containing aqueous solution is prepared. After the cellulose fiber nano-dispersion has been spread in the water layer side in the oil reservoir of the well, the valve b2 is opened, and by a pump p3, the above-prepared polyvalent metal salt-containing aqueous solution is pressed into the well through the tubing 1 in the casing 2. Subsequently, the valve b5 is closed, and while the pressurized state is kept as such, the well is kept closed until the cellulose fibers could be gelled. With that, as shown in the drawing, after water is blocked out by the gel, the valves b1, b2, b3, and b6 are closed, b4 is opened and further the valve b5 is opened (to open the closed well). Accordingly, in the state where water is blocked out from the high-penetration zone in the oil reservoir of the well, the hydrocarbon remaining in the low-penetration zone is recovered through the tubing 1 in the casing 2, whereby the production amount of water from the oil reservoir (accompanying water) can be reduced and, as a result, the hydrocarbon recovery rate can be increased. The produced hydrocarbon and water are, after drawn out through the tubing 1 in the casing 2 optionally by using the pump p4, separated in a separation tank 6. In that manner, hydrocarbon is recovered, and water is desalted, for example, by a desalting machine 7, then transferred into a water tank 9 and is thus recycled.

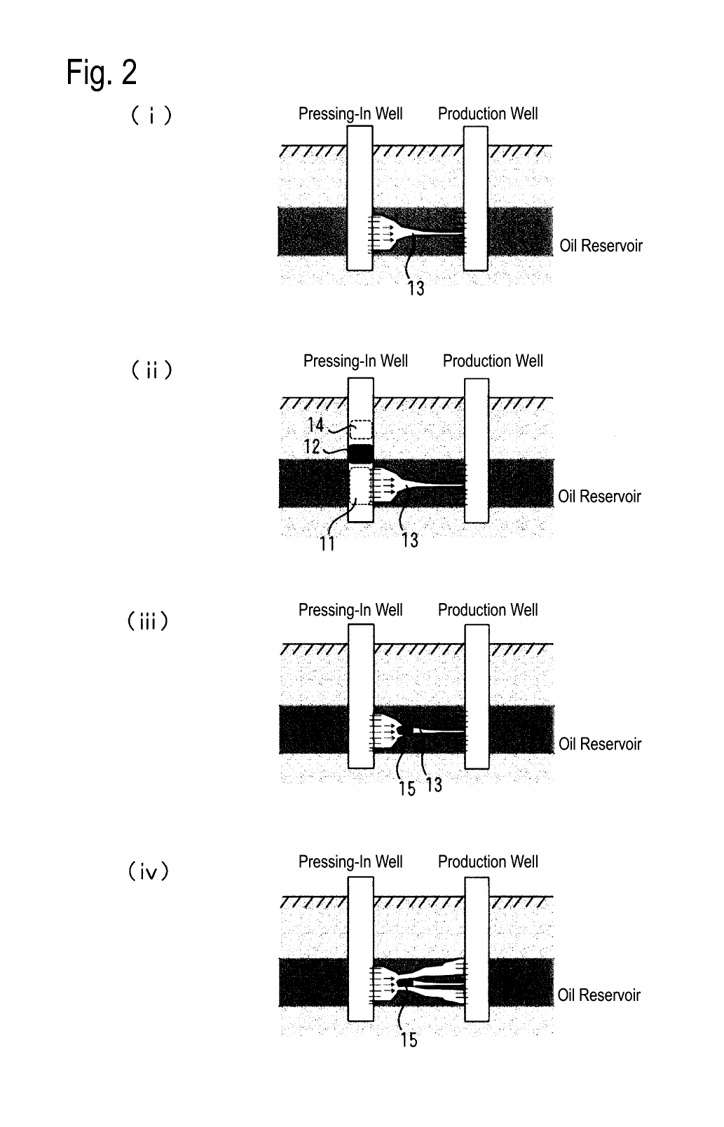

Another example of the hydrocarbon production method of the present invention is described with reference to FIG. 2. In this example, as illustrated in (i) of FIG. 2, the pressing-in well and the production well are different wells. As illustrated in (ii) of FIG. 2, first, clear water 11 as preceding water is optionally pressed in to remove salts as much as possible from the flow channel, and then a pressed-in fluid 12 formed by pressing in the nano-dispersion of cellulose fibers and the polyvalent metal salt-containing aqueous solution is introduced into a prevailing flow channel 13 between the pressing-in well and the production well. The cellulose fiber nano-dispersion and the polyvalent metal salt-containing aqueous solution may be, before pressed into the pressing-in well, gently stirred, and further if desired, a friction reducing agent, a surfactant, an emulsification inhibitor, a germicide, or the like may be added and gently stirred, and the resultant pressed-in fluid (slag) 12 may be pressed into the pressing-in well. Optionally, the slag 12 may be conveyed to the prevailing flow channel 13 by boosting water 14 or the like, as illustrated in the drawing. In that manner, as illustrated in (iii) of FIG. 2, after the prevailing flow channel 13 is blocked out by a gel 15 of the slag, water and gas are further pressed in through the pressing-in well, whereby the flow channel of the pressed-in fluid is changed as illustrated in (iv) of FIG. 2, and the hydrocarbon in the non-swept site left in the oil reservoir is thus expelled out toward the production well, thereby enabling an increase of the hydrocarbon recovery rate.

When the cellulose fibers of the conifer-derived pulp for use in the hydrocarbon production method of the present invention is used as a so-called thickener, the cellulose fiber nano-dispersion may be pressed in through a well, and the liquid hydrocarbon in the oil reservoir targeted by the well may be extruded out into another well that is connected via the oil reservoir, like in a polymer flood process, and the liquid hydrocarbon recovery rate can be thereby increased. In such liquid hydrocarbon enhanced recovery method (EOR), it is unnecessary to crosslink cellulose fibers and therefore a crosslinking agent is unnecessary and it is also unnecessary to block out the pressing-in flow channel to be kept static for a predetermined period of time. Also in such liquid hydrocarbon enhanced recovery method (EOR), the cellulose fiber nano-dispersion pressing-in device of the present invention is favorably used.

In the hydrocarbon production method of the present invention, the pressure in pressing the cellulose fiber nano-dispersion and the aqueous solution of a polyvalent metal salt into a well is, from the viewpoint of recovery efficiency or the like, preferably set so that the well bottom pressure could be higher by 0.1 to 100 atm than the oil reservoir pressure and more preferably regulated so that the pressing-in pressure could be higher by 1 to 30 atom than the oil reservoir pressure.

In the cellulose fiber nano-dispersion, the solid content of the cellulose fibers is generally within a range of 0.01 to 10% by weight of the entire dispersion, preferably within a range of 0.1 to 1% by weight of the entire dispersion and more preferably within a range of 0.1 to 0.2% by weight of the entire dispersion. Specifically, this is because, as described above, even when the amount of the cellulose fibers is small, good pseudoplastic flowability can be expressed, and a sufficient water-stopping effect can be realized. The hardly-soluble polyvalent metal salt content in the aqueous solution of polyvalent metal salt is preferably within a range of 0.001 to 1% by weight of the entire aqueous solution.

Here, the cellulose fiber nano-dispersion for use in the present invention, the cellulose fibers have a number-average fiber diameter of generally 2 to 500 nm, and from the viewpoint of dispersion stability and water-stopping performance, preferably 2 to 150 nm, more preferably 2 to 100 nm and even more preferably 3 to 80 nm. Specifically, this is because, when the number-average fiber diameter is too small, naturally they may be dissolved in the dispersion medium, but on the contrary, when the number-average fiber diameter is too large, the cellulose fibers may precipitate and therefore could not express the function to be attained by incorporation of the cellulose fibers. The maximum fiber diameter of the cellulose fibers is 1000 nm or less and preferably 500 nm or less. Specifically, this is because, when the maximum fiber diameter of the cellulose fibers is too large, the cellulose fibers may precipitate and the ability of the cellulose fibers to express the function thereof tends to lower.

The number-average fiber diameter and the maximum fiber diameter of the cellulose fibers may be measured, for example, as follows. Specifically, an aqueous dispersion of fine cellulose having a solid fraction of 0.05 to 0.1% by weight is prepared, and the dispersion is cast onto a carbon film-coated grid, which has been subjected to hydrophilization, to prepare a sample for observation of a transmission electron microscope (TEM). When fibers having a large fiber diameter are contained, a scanning electron microscopic (SEM) image of the surface of the one cast onto the glass may be observed. Depending on the size of the constituent fibers, an observation with electron microscopic images is carried out at any magnification power of 5,000 times, 10,000 times or 50,000 times. On this occasion, an axis of the image width in any of the lengthwise direction and the crosswise direction is simulated on the taken image, and the sample and the observation conditions (magnification power, etc.) are controlled in such that 20 or more fibers could intersect with the axis. After an observation image satisfying the condition is taken, random two axes per image are drawn on this image, both in the vertical direction and the horizontal direction, and the fiber diameter of the fibers intersecting the axis is read visually. In that manner, at least three images of a non-overlapping surface part are taken with an electron microscope, and the values of the fiber diameter of the fibers intersecting with each of the two axes are read (accordingly, information of a fiber diameter of at least 20×2×3=120 fibers is obtained). From the fiber diameter data thus obtained, the maximum fiber diameter and the number-average fiber diameter are calculated.

The aspect ratio of the cellulose fibers is generally 50 or more, but is preferably 100 or more and more preferably 200 or more. Specifically, this is because, when the aspect ratio is too small, sufficient pseudoplastic flowability could not be realized.

The aspect ratio of the cellulose fibers may be measured, for example, according to the following method. Specifically, the cellulose fibers are cast onto a carbon film-coated grid, which has been subjected to hydrophilization, and then negatively stained with 2% uranyl acetate, and from the TEM image thereof (magnification power: 10000 times), the number-average fiber diameter and the fiber length of the cellulose fibers are calculated according to the previously described method, and using these values, the aspect ratio can be calculated according to the following formula (1).

[Math. 1]

Aspect Ratio=number-average fiber length (nm)/number-average fiber diameter (nm) (1)

The cellulose fibers are fibers prepared by finely pulverizing a naturally-derived cellulose solid raw material having I-type crystal structure. Specifically, in conifer-derived pulp, nanofibers called microfibrils are first formed, and these are multi-bundled to constitute a high-order solid structure. Here, that cellulose constituting the cellulose fibers has a I-type crystal structure can be identified, for example, by that typical peaks appear at two positions near 2θ=14 to 17° and near 2θ=22 to 23° in a diffraction profile obtained in wide-angle X-ray diffraction image observation.

If desired, in the cellulose fibers, the hydroxyl groups on the surfaces of the cellulose fibers are chemically modified. Examples of the chemically-modified cellulose include cellulose oxide, carboxymethyl cellulose, multivalent carboxymethyl cellulose, long-chain carboxy cellulose, primary aminocellulose, cationized cellulose, secondary aminocellulose, methyl cellulose, and long-chain alkyl cellulose. Above all, cellulose oxide is preferred as excellent in the selectivity of the hydroxyl groups on the fiber surfaces and capable of acting under a mild reaction condition. In the present invention, those having a carboxymethyl group content, a carboxyl group content or the like of less than 0.1 mmol/g are considered as those not satisfying the condition that “the hydroxyl groups in the surfaces of the cellulose fibers are chemically modified”.

The above-mentioned cellulose oxide may be obtained according to a production method including an oxidation step of oxidizing a conifer-derived pulp by using the conifer-derived pulp as a starting material and an N-oxyl compound as an oxidation catalyst, and by a reaction with a co-oxidizing agent in water to give a reaction product of fibers, a purifying step of removing impurities to give water-impregnated reaction product fibers, and a dispersion step of dispersing the water-impregnated reaction product fibers in a solvent.

In addition, in the cellulose fibers for use in the present invention, it is preferable that, for example, the C6-positioned hydroxyl group in each glucose unit in the cellulose molecule has selectively undergone oxidative modification to be any of an aldehyde group, a ketone group and a carboxyl group. The carboxyl group content (carboxyl group amount) is preferably within a range of 1.2 to 2.5 mmol/g and more preferably 1.5 to 2.0 mmol/g. This is because, when the carboxyl group amount is too small, the cellulose fibers may precipitate or aggregate, but when the carboxyl group amount is too large, the solubility in water of the fibers may be too large.

For measurement of the carboxyl group amount in the cellulose fibers, for example, 60 ml of a 0.5 to 1 wt % slurry of a cellulose sample whose dry weight has been measured accurately is prepared, and its pH is controlled to be about 2.5 with an aqueous solution of 0.1 M hydrochloric acid, and then an aqueous solution of 0.05 M sodium hydroxide is dropwise added for measurement of electroconductivity. The measurement is continued until the pH could reach about 11. From the amount of sodium hydroxide (V) consumed in the neutralization stage with a weak acid whose electroconductivity change is mild, the carboxyl group amount can be calculated according to the following formula (2).

[Math. 2]

Carboxyl Group Amount (mmol/g)=V (ml)×[0.05/cellulose weight] (2)

The carboxyl group amount may be controlled by controlling the addition amount of the co-oxidizing agent to be used in the oxidation step for the cellulose fibers and the reaction time, as described below.

Preferably, the cellulose fibers are reduced with a reducing agent after the oxidation modification. Accordingly, a part or all of the aldehyde groups and the ketone groups can be reduced to return to hydroxyl groups. The carboxyl groups are not reduced. Through the reduction, it is preferable that the total content of the aldehyde groups and the ketone groups in the cellulose fibers, as measured according to a semicarbazide method, is controlled to be 0.3 mmol/g or less, especially preferably within a range of 0 to 0.1 mmol/g and most preferably substantially 0 mmol/g. Accordingly, those may have increased dispersion stability, and especially may have excellent dispersion stability for a long period of time, not influenced by temperatures, etc, as compared with those that have been merely oxidatively modified.

Preferably, from the viewpoint of readily realizing the characteristics needed in the hydrocarbon production method of the present invention, the cellulose fibers are those oxidized by using a co-oxidizing agent in the presence of an N-oxyl compound such as 2,2,6,6-tetramethylpiperidine (TEMPO) or the like, and those in which the aldehyde groups and the ketone groups which have been formed through the oxidation reaction are reduced with a reducing agent. More preferably, from the above-mentioned viewpoint, the reduction with a reducing agent is with sodium borohydride (NaBH₄).

The measurement of the total content of the aldehyde groups and the ketone groups according to a semicarbazide method is carried out, for example, as follows. Specifically, accurately 50 ml of 3 g/l aqueous solution of semicarbazide hydrochloride controlled to have pH of 5 with a phosphate buffer is added to a dried sample followed by sealing up and shaking for 2 days. Next, accurately 10 ml of the solution is taken in a 100-ml beaker, and 25 ml of 5 N sulfuric acid and 5 ml of an aqueous 0.05 N potassium iodate solution are added thereto, followed by stirring for 10 minutes. Subsequently, 10 ml of an aqueous 5% potassium iodide solution is added, and immediately a titration is carried out by using an automatic titration device, with a 0.1 N sodium thiosulfate solution. From the titration amount and the like, the carbonyl group amount (total content of aldehyde groups and ketone groups) in the sample can be determined according to the following formula (3). Semicarbazide reacts with an aldehyde group and a ketone group to form a Schiff base (imine) but does not react with a carboxyl group. Accordingly, it is considered that aldehyde groups and ketone groups alone can be quantitatively determined by the above-mentioned measurement.

[Math. 3]

Carbonyl Group Amount (mmol/g)=(D−B)×f×[0.125/w] (3)

D: titration amount in sample (ml)

B: titration amount in blank test (ml)

f: factor of 0.1 N sodium thiosulfate solution (-)

w: sample amount (g)

As previously described, it is preferable that, in the cellulose fibers for use in the present invention, the C6-positioned hydroxyl groups alone in each glucose unit in the cellulose molecules in the fiber surfaces have selectively undergone oxidative modification to be any of an aldehyde group, a ketone group and a carboxyl group. Whether the C6-positioned hydroxyl groups alone in the glucose units in the surfaces of the cellulose fibers are selectively oxidized can be confirmed, for example, by the ¹³C-NMR chart. Specifically, the 62 ppm peak corresponding to the C6-position of a primary hydroxyl group in the glucose unit that can be confirmed in the ¹³C-NMR chart of cellulose before oxidation disappears after oxidation reaction, and in place of it, a peak derived from a carboxyl group or the like appears (the 178 ppm peak is derived from a carboxyl group). In that manner, that the C6-positioned hydroxyl groups alone in the glucose unit are oxidized to carboxyl groups and the like can be confirmed.

The aldehyde groups in the cellulose fibers can be detected, for example, with a Fehling's reagent. Specifically, for example, a Fehling's reagent (mixed solution of sodium potassium tartrate and sodium hydroxide, and aqueous solution of copper sulfate penta-hydrate) is added to a dried sample, followed by heating at 80° C. for 1 hour. When the resultant supernatant is blue and the part of the cellulose fibers is navy blue, it can be judged that the no aldehyde group could be detected and when the supernatant is yellow and the part of the cellulose fibers is red, it can be judged that aldehyde groups could be detected.

The cellulose fiber nano-dispersion for use in the present invention can be obtained by carrying out the (4) dispersion step (finely pulverizing step) or the like to be mentioned hereinunder, with conifer-derived pulp as a material and by using the cellulose fiber nano-dispersion pressing-in device of the present invention or the like. It can be obtained by, preferably, carrying out the (1) oxidation reaction step, (2) the reduction step and (3) the purification step to be mentioned hereinunder, and then carrying out the (4) dispersion step (finely pulverizing step). The steps are successively described hereinunder.

### (1) Oxidation Step

After conifer-derived pulp and an N-oxyl compound are dispersed in water (dispersion medium), a co-oxidizing agent is added and the reaction is started. During the reaction, an aqueous solution of 0.5 M sodium hydroxide is dropwise added to thereby keep the pH at 10 to 11, and at the time when no pH change is seen, the reaction is considered to be ended. Here, the co-oxidizing agent is not a substance that directly oxidizes the cellulose hydroxyl group in the conifer-derived pulp but is a substance that oxidizes the N-oxyl compound used as an oxidation catalyst.

Preferably, the conifer-derived pulp is treated for increasing the surface area thereof, for example, by beating or the like, since the reaction efficiency thereof can be thereby increased and since the productivity can be thereby enhanced. Also preferably, as the conifer-derived pulp, one stored without being dried after isolation (never-dried) is used, since the microfibril aggregates thereof are in the form that can readily swell and since the reaction efficiency can be increased and the number-average fiber diameter after the finely-pulverizing treatment can be reduced.

The dispersion medium for the conifer-derived pulp in the reaction is water, and the conifer-derived pulp concentration in the aqueous reaction solution may be any concentration capable of realizing sufficient diffusion of the reagent (conifer-derived pulp) therein. In general, it is about 5% or less relative to the weight of the aqueous reaction solution, but by using a device having a strong mechanical stirring power, the reaction concentration can be increased.

As the N-oxyl compound, for example, there can be mentioned a compound having a nitroxy radical and generally used as an oxidation catalyst. The N-oxyl compound is preferably a water-soluble compound, and above all, a piperidine nitroxy oxyradical is preferred, and especially 2,2,6,6-tetramethylpiperidinoxy radical (TEMPO) or 4-acetamide-TEMPO is preferred. Addition of a catalytic amount of the N-oxyl compound is enough, and preferably, it is added to the aqueous reaction solution in an amount falling within a range of 0.1 to 4 mmol/1 and more preferably 0.2 to 2 mmol/1.

Examples of the co-oxidizing agent include hypohalous acids and salts thereof, halous acids and salts thereof, perhalogen acids and salts thereof, hydrogen peroxide, perorganic acids, etc. One alone or two or more kinds combined of these may be used. Above all, alkali metal hypohalites such as sodium hypochlorite, sodium hypobromite and the like are preferred. When sodium hypochlorite is used, it is preferable from the viewpoint of the reaction speed that the reaction is carried out in the presence of an alkali metal bromide such as sodium bromide, etc. The amount of the alkali metal bromide to be added may be about 1 to 40 molar times and preferably about 10 to 20 molar times that of the N-oxyl compound.

Preferably, the pH of the aqueous reaction solution is maintained to fall within a range of about 8 to 11. The temperature of the aqueous solution may be any one falling within a range of about 4 to 40° C., but the reaction may be carried out at room temperature (25° C.) and any specific temperature control is unnecessary. For obtaining a desired carboxyl group amount, etc., the oxidation degree is controlled by the addition amount of the co-oxidizing agent and the reaction time. In general, the reaction time is about 5 to 120 minutes, and the reaction may finish within at most 240 minutes.

### (2) Reduction Step

Preferably, after the oxidation reaction, the cellulose fibers are further subjected to reduction reaction. Specifically, after oxidized, the cellulose oxide is dispersed in pure water, then the pH of the aqueous dispersion is controlled to be about 10, followed by a reduction reaction with any of various reducing agents. The reducing agent for use in the present invention may be any ordinary one, and preferred examples thereof include LiBH₄, NaBH₃CN, NaBH₄, etc. Above all, NaBH₄ is preferred form the viewpoint of cost and utility.

The amount of the reducing agent is preferably within a range of 0.1 to 4% by weight based on cellulose oxide, more preferably within a range of 1 to 3% by weight. The reaction is carried out at room temperature or at a temperature somewhat higher than room temperature generally for 10 minutes to 10 hours and preferably 30 minutes to 2 hours.

After the completion of the above reaction, the pH of the reaction mixture is controlled to be about 2 with any of various acids, and solid-liquid separation with a centrifuge is carried out while pure water is sprayed, thereby giving cake-like cellulose oxide. The solid-liquid separation is carried out until the electroconductivity of the filtrate could reach 5 mS/m or less.

### (3) Purification Step

Next, for removing an unreacted co-oxidizing agent (hypochlorite, etc.), various side products and others, purification is carried out. In general, the reaction product fibers are not discretely dispersed on a nano-fiber unit level in this stage, and are therefore processed in an ordinary purification method, that is, washing with water and filtration are repeated to give a dispersion of reaction product fibers having a high purity (99% by weight or more) and water.

In the purification method for the purification step, any apparatus can be used with no problem as long as it is an apparatus capable of attaining the above-mentioned object, for example, as in a method utilizing centrifugal dewatering (for example, a continuous-type decanter). The aqueous dispersion of reaction product fibers thus obtained has, in the squeezed form thereof, a solid (cellulose) concentration falling within a range of about 10% by weight to 50% by weight. In consideration of the dispersion step to follow, a solid concentration of higher than 50% by weight is unfavorable since extremely high energy would be required for dispersion.

### (4) Dispersion Step (Finely Pulverizing Step)

The water-containing reaction product fibers obtained in the above purification step (aqueous dispersion) are dispersed in a dispersion medium to carry out a dispersion treatment. Along with the treatment, the viscosity increases to give a dispersion of finely pulverized cellulose fibers. Subsequently, if desired, the cellulose fibers may be dried. Regarding the drying method for the dispersion of cellulose fibers, for example, in the case where the dispersion medium is water, a spray drying, a freeze drying method, a vacuum drying method, or the like may be used. In the case where the dispersion medium is a mixed solution of water and an organic solvent, a drying method with a drum drier, a spray drying method with a spray drier or the like may be used. Without drying the dispersion of cellulose fibers, the dispersion as it is may be used in the hydrocarbon production method of the present invention with no problem.

As the disperser for use in the dispersion step, use of an apparatus being powerful and having a beating ability, such as a homomixer with a high-rotation, a high-pressure homogenizer, an ultrahigh-pressure homogenizer, ultrasonic dispersion processor, a beater, a disc-type refiner, a conical-type refiner, a double disc-type refiner, a grinder, or the like, is preferred as enabling more efficient and higher level downsizing and as sterilizing microorganisms such as bacteria and the like adhering to the cellulose fibers. As the disperser, for example, a screw-type mixer, a paddle mixer, a disper-type mixer, a turbine-type mixer, a disper, a propeller mixer, a kneader, a blender, a homogenizer, an ultrasonic homogenizer, a colloid mill, a pebble mill, a bead mill grinder, and the like may also be used with no problem. Two or more kinds of disperser may be used in combination with no problem.

As in the above, the cellulose fiber nano-dispersion for use in the present invention can be obtained.

As the polyvalent metal salt that is used as needed in the hydrocarbon production method of the present invention, specifically, use can be made of a hardly-soluble polyvalent metal salt having a polyvalent metal ion such as an aluminum ion, a magnesium ion or a calcium ion. Use of such a hardly-soluble polyvalent metal salt can solve the problem of environmental load. Above all, from the viewpoint of solubility in water and uniform dispersibility in dissolution, basic aluminum acetate, aluminum potassium sulfate anhydride (potash alum), calcium carbonate, and aluminum stearate are preferred.

Examples of other additives that may be added as needed to the cellulose fiber nano-dispersion include surfactants [surfactants described in U.S. Pat. No. 4,331,447, for example, polyoxyethylene nonylphenol ether, sodium dioctylsulfosuccinate, etc.], antioxidants [phenolic compounds (hydroquinone, catechol, etc.), hindered amines [2-(5-methyl-2-hydroxyphenyl)benzotriazole, dimethyl succinate-1-(2-hydroxyethyl)-4-hydroxy-2,2,6,6-tetramethylpiperidine polycondensate, bis(1-octyloxy-2,2,6,6-tetramethyl-4-piperidyl) sebacate, etc.], sulfur-containing compounds [2-mercaptobenzothiazole and its salts (metal salts, ammonium salts, etc.), thiourea, tetramethylthiuram disulfide, dimethyldithiocarbamic acid and its salts (metal salts, ammonium salts, etc.), sodium sulfite, sodium thiosulfate, etc.], phosphorus-containing compounds (triphenyl phosphite, triethyl phosphite, sodium phosphite, sodium hypophosphite, etc.), nitrogen-containing compounds (guanidine sulfate, etc.)], glycols (ethylene glycol, propylene glycol, 1,3-butanediol, glycerin, etc.), minerals (silica, clay, smectite, montmorillonite, etc.), etc. Regarding the content of the other additives, it is preferably incorporated in 5% by weight or less of the cellulose fiber nano-dispersion.

The oil reservoir suitable for carrying out the hydrocarbon production method of the present invention include sandstone layers, conglomerate layers, limestone layers, granite layers, and shale strata to which a hydraulic fracture technique is applied, and from the viewpoint of the penetrability of the cellulose fiber nano-dispersion, the penetration ratio is 10 millidarcy or more and preferably 50 millidarcy or more.

The hydrocarbon production method of the present invention may be applied to wells in which the ratio of water to production fluid has increased, thereby reducing the labor and cost for accompanying water treatment and improving the crude oil/gas recovery rate. In addition, from the viewpoint of improving the sweeping efficiency for oil through pressing-in of water and gas, the hydrocarbon production method of the present invention is extremely effective.

### EXAMPLES

Next, Examples are described along with Comparative Examples, etc. However, the present invention is not limited to these Examples. In Examples, “%” is based on weight unless otherwise specifically indicated.

### Examples 1 to 12, Reference Example and Comparative Examples 1 to 5

### Preparation of Cellulose Fibers A1 (for Examples)

Into a mixed liquid of 435 g of isopropanol (IPA), 65 g of water and 9.9 g of NaOH was put 100 g of coniferous pulp, followed by stirring at 30° C. for 1 hour. To the slurry was added 23.0 g of IPA solution of 50% monochloroacetic acid, followed by heating up to 70° C. and a reaction for 1.5 hours. The resultant reaction product was washed with 80% methanol, then substituted with methanol and dried to give carboxymethylated cellulose fibers. Next, pure water was added to the cellulose fibers to dilute into 2%, followed by processing once with a high-pressure homogenizer (STAR BURST manufactured by Sugino Machine Limited) under a pressure of 100 MPa to prepare cellulose fibers A1.

### [Preparation of Cellulose Fibers A2 (for Examples)]

To 2 g of coniferous pulp were added 150 ml of water, 0.25 g of sodium bromide and 0.025 g of TEMPO, followed by fully stirring to disperse. An aqueous solution of 13 wt % sodium hypochlorite (co-oxidizing agent) was then added thereto so that the amount of sodium hypochlorite per 1.0 g of the pulp could be 5.2 mmol/g, and the reaction was started. With the reaction going on, the pH lowered and therefore an aqueous solution of 0.5 N sodium hydroxide was added dropwise so as to keep the pH at 10 to 11, and the reaction was continued until no pH change could be detected (reaction time: 120 minutes). After the completion of the reaction, 0.1 N hydrochloric acid was added for neutralization, followed by purification by repeated filtration and washing with water to thereby give cellulose fibers whose fiber surfaces were oxidized. Next, pure water was added to the cellulose fibers to dilute them into 2%, followed by processing once with a high-pressure homogenizer (STAR BURST manufactured by Sugino Machine Limited) under a pressure of 100 MPa to prepare cellulose fibers A2.

### [Preparation of Cellulose Fibers A3 (for Examples)]

Cellulose fibers A3 were prepared according to the preparation method for the cellulose fibers A2 except that the addition amount of the aqueous sodium hypochlorite solution was changed to 6.5 mmol/g per 1.0 g of the pulp.

### [Preparation of Cellulose Fibers A4 (for Examples)]

Cellulose fibers A4 were prepared according to the preparation method for the cellulose fibers A2 except that the addition amount of the aqueous sodium hypochlorite solution was changed to 12.0 mmol/g per 1.0 g of the pulp.

### [Preparation of Cellulose Fibers A5 (for Examples)]

Coniferous pulp was oxidized according to the same method as in the preparation method for the cellulose fibers A2, and then processed for solid-liquid separation with a centrifuge, and water was added thereto to control the solid concentration to be 4%. Subsequently, the pH of the slurry was controlled to be 10 with aqueous 24% NaOH solution. The slurry temperature was made to be 30° C., and sodium borohydride was added to the cellulose fibers in an amount of 0.2 mmol/g, followed by carrying out a reaction for 2 hours for a reducing treatment. After the reaction, 0.1 N hydrochloric acid was added for neutralization, followed by purification by repeated filtration and washing with water to give cellulose fibers. Next, pure water was added to the cellulose fibers to dilute them into 2%, followed by processing once with a high-pressure homogenizer (STAR BURST manufactured by Sugino Machine Limited) under a pressure of 100 MPa to prepare cellulose fibers A5.

### [Preparation of Cellulose Fibers A6 (for Examples)]

Coniferous pulp was oxidized according to the same method as in the preparation method for the cellulose fibers A3, and then reduced and purified according to the same method as in the preparation method for the cellulose fibers A5. Next, pure water was added to the cellulose fibers to dilute them into 2%, followed by processing once with a high-pressure homogenizer (STAR BURST manufactured by Sugino Machine Limited) under a pressure of 100 MPa to prepare cellulose fibers A6.

### [Preparation of Cellulose Fibers A7 (for Examples)]

Coniferous pulp was oxidized according to the same method as in the preparation method for the cellulose fibers A4, and then reduced and purified according to the same method as in the preparation method for the cellulose fibers A5. Next, pure water was added to the cellulose fibers to dilute them into 2%, followed by processing once with a high-pressure homogenizer (STAR BURST manufactured by Sugino Machine Limited) under a pressure of 100 MPa to prepare cellulose fibers A7.

### [Preparation of Cellulose Fibers A′1 (for Reference Example)]

In 4950 g of water was dispersed 50 g of needle bleached kraft pulp (NBKP) to prepare a dispersion having a pulp concentration of 1% by weight. The dispersion was processed 30 times with CERENDIPITOR MKCA6-3 (manufactured by Masuko Sangyo Co., Ltd.) to prepare cellulose fibers A′1.

### [Preparation of Cellulose Fibers A′2 (for Comparative Example)]

Cellulose fibers A′2 were prepared according to the preparation method for the cellulose fibers A2 except that regenerated cellulose was used in place of the coniferous pulp as a raw material and that the addition amount of the aqueous sodium hypochlorite solution was changed to 27.0 mmol/g per 1.0 g of the regenerated cellulose.

The cellulose fibers A1 to A7, A′1 and A′2 prepared in the manner as above were evaluated for the characteristics thereof according to the criteria mentioned below. The results are shown in Table 1 given hereinunder.

### <Crystal Structure>

By using an X-ray diffractometer (RINT-Ultima 3, manufactured by Rigaku Corporation), the diffraction profile of cellulose fibers was analyzed. Those having typical peaks at two positions near 2θ=14 to 17° and near 2θ=22 to 23° were evaluated as “present” as having a crystal structure (I-type crystal structure), and those not having the peaks were evaluated as “absent”.

### <Measurement of Number-Average Fiber Diameter and Aspect Ratio>

The number-average fiber diameter and the fiber length of the cellulose fibers were observed with a transmission electron microscope (TEM) (JEM-1400 manufactured by JEOL). Specifically, the cellulose fibers were cast onto a carbon film-coated grid, which has been subjected to hydrophilization, and then negatively stained with 2% uranyl acetate, and from the TEM image thereof (magnification power: 10000 times), the number-average fiber diameter and the fiber length were calculated according to the previously described method. By using these values, the aspect ratio was calculated according to the following formula (1).

[Math. 4]

Aspect Ratio=number-average fiber length (nm)/number-average fiber diameter (nm) (1)

### <Measurement of Carboxymethyl Group Amount and Carboxyl Group Amount>

In water were dispersed 0.25 g of cellulose fibers to prepare 60 ml of an aqueous cellulose dispersion, and its pH was controlled to be about 2.5 with an aqueous solution of 0.1 M hydrochloric acid, and then an aqueous solution of 0.05 M sodium hydroxide was dropwise added for measurement of electroconductivity. The measurement was continued until the pH reached about 11. From the amount of sodium hydroxide (V) consumed in the neutralization stage with a weak acid whose electroconductivity change was mild, the carboxyl group amount (the carboxylmethyl group amount only in the cellulose fibers A1) was calculated according to the following formula (2).

[Math. 5]

Carboxyl Group Amount (or carboxymethyl group amount) (mmol/g)=V (ml)×[0.05/cellulose weight] (2)

### <Measurement of Carbonyl Group Amount (Semicarbazide Method)>

About 0.2 g of cellulose fibers were accurately weighed, and accurately 50 ml of 3 g/l aqueous solution of semicarbazide hydrochloride controlled to have pH of 5 with a phosphate buffer was added thereto, followed by sealing up and shaking for 2 days. Next, accurately 10 ml of the solution was taken in a 100-ml beaker, and 25 ml of 5 N sulfuric acid and 5 ml of an aqueous 0.05 N potassium iodate solution were added thereto, followed by stirring for 10 minutes. Subsequently, 10 ml of an aqueous 5% potassium iodide solution was added, and immediately a titration was carried out by using an automatic titration device, with a 0.1 N sodium thiosulfate solution. From the titration amount and the like, the carbonyl group amount (total content of aldehyde groups and ketone groups) in the sample was determined according to the following formula (3).

[Math. 6]

Carbonyl Group Amount (mmol/g)=(D−B)×f×[0.125/w] (3)

D: titration amount in sample (ml)

B: titration amount in blank test (ml)

f: factor of 0.1 N sodium thiosulfate solution (-)

w: sample amount (g)

### <Detection of Aldehyde Group>

To 0.4 g of cellulose fibers accurately weighed was added a Fehling's reagent prepared according to the Japanese Pharmacopoeia (5 ml of a mixed solution of sodium potassium tartrate and sodium hydroxide, and 5 ml of an aqueous solution of copper sulfate penta-hydrate), followed by heating at 80° C. for 1 hour. When the resultant supernatant was blue and the part of the cellulose fibers was navy blue, it was judged that the no aldehyde group was detected, which was thus evaluated as “absent”. When the supernatant was yellow and the part of the cellulose fibers was red, it was judged that aldehyde groups were detected, which was thus evaluated as “present”.

TABLE 1

| | Cellulose Fibers | | | | | | | | |
|---|---|---|---|---|---|---|---|---|---|
| | A1 | A2 | A3 | A4 | A5 | A6 | A7 | A′1 | A′2 |
| Added Amount of Sodium | — | 5.2 | 6.5 | 12 | 5.2 | 6.5 | 12 | — | 27 |
| Hypochlorite [mmol/g] | | | | | | | | | |
| Crystal Structure | present | present | present | present | present | present | present | present | absent |
| Number-Average Fiber Diameter | 300 | 89 | 54 | 11 | 58 | 23 | 4 | 250 | * |
| [nm] | | | | | | | | | |
| Aspect Ratio | 136 | 92 | 134 | 242 | 127 | 209 | 280 | 56 | unmeasurable |
| Carboxyl Group Amount [mmol/g] | 1.2 | 1.2 | 1.6 | 2 | 1.2 | 1.6 | 2 | <0.1 | 3.1 |
| (carboxymethyl group amount in A1) | | | | | | | | | |
| Carbonyl Group Amount [mmol/g] | <0.1 | 0.37 | 0.43 | 0.42 | 0.14 | 0.23 | 0.3 | <0.1 | 0.59 |
| Detection of Aldehyde Group | absent | present | present | present | absent | absent | absent | absent | present |

*: Unmeasurable since the number-average fiber diameter was 1 nm or less.

As described above, in the cellulose fibers A′1, the hydroxyl groups in the fiber surfaces are not chemically modified, and the cellulose fibers A′2 do not have a cellulose I-type crystal structure. Regarding the cellulose fibers A2 to A7, whether the C6-positioned hydroxyl groups alone in each glucose unit in the surfaces of the cellulose fibers are selectively oxidized into carboxyl groups and the like was confirmed by the ¹³C-NMR chart. Specifically, the 62 ppm peak corresponding to the C6-position of the primary hydroxyl group in the glucose unit which can be confirmed in the ¹³C-NMR chart of cellulose before oxidation disappeared after oxidation reaction, and in place of it, a peak derived from a carboxyl group appeared at 178 ppm. From this, it was confirmed that in the cellulose fibers A2 to A7, the C6-positioned hydroxyl group alone in each glucose unit was oxidized into an aldehyde group or the like.

### Example 1

The cellulose fibers A1 obtained in the manner as above were evaluated in point of the viscosity degradation thereof owing to mechanical shear, in the manner mentioned below. Specifically, pure water was added to the cellulose fibers A1 to dilute them to have a solid concentration of 0.5%, followed by stirring at 4,000 rpm for 5 minutes by using a homomixer MARK II 2.5 Model (manufactured by PRIMIX Corporation) to give a test liquid. Next, the test liquid was left statically at 25° C. for one day, and then by using a B-type viscometer (manufactured by Brookfield Engineering Laboratories, Rotor No. 4, 6 rpm, 3 minutes, 25° C.), the viscosity thereof was measured. Subsequently, by using a water bath, this was heated up to 60° C., and while the temperature thereof was kept at 60° C., the test liquid was stirred (subjected to shearing treatment) at 12,000 rpm for 60 minutes, by using a homomixer MARK II 2.5 Model (manufactured by PRIMIX Corporation). Subsequently, the processed liquid was further left statically at 25° C. for one day, and then using a B-type viscometer (manufactured by Brookfield Engineering Laboratories, Rotor No. 4, 6 rpm, 3 minutes, 25° C.), the viscosity thereof was measured. From the viscosity before and after the shearing treatment, the viscosity retention rate (%) was calculated according to the following formula (4), and the degree of viscosity degradation was evaluated according to the following criteria. As a result, evaluation “A” was obtained.

[Math. 7]

Viscosity Retention Rate (%)=[viscosity after shearing treatment (mPa·s)/viscosity before shearing treatment (mPa·s)]×100 (4)

A: The viscosity retention rate was 85% or more.

B: The viscosity retention rate was 70% or more and less than 85%.

C: The viscosity retention rate was 55% or more and less than 70%.

D: The viscosity retention rate was less than 55%.

Next, the cellulose fibers A1 serving as a gelling agent were diluted into pure water (diluted such that the cellulose fibers A1 could account for 0.5% by weight of the entire amount of the composition), then basic aluminum acetate serving as a crosslinking agent was added in an amount of 0.2% by weight of the entire amount of the composition, followed by stirring at 4000 rpm for 10 minutes with T. K. Homomixer (manufactured by PRIMIX Corporation). The stirred product was evaluated for the characteristics thereof according to the following criteria. In either test, evaluation “good” was obtained.

### [Gelation]

After being transferred into a glass bottle and statically left therein for one day, those that did not gel (or gelled insufficiently) and flew out automatically from the container when the glass bottle was tilted were evaluated as “poor”, while those that gelled well and were taken out as one lump from the container or did not flow out from the container were evaluated as “good”.

### [Environmental Load]

Those in which a substance having an environmental load (a substance that may remain in the ground or may flow out in underground water and therefore may give some health damage to the neighboring residents) was used as any of the gelling agent and the crosslinking agent were evaluated as “poor”, while those in which any substance having an environmental load was not used as both the gelling agent and the crosslinking agent were evaluated as “good”.

### [Measurement of Viscosity at 6 rpm and Thixotropic Index (TI)]

Of the liquid sample prepared in the manner as above, 250 g was left statically at 25° C. for one day and then, the viscosity thereof was measured by using a B-type viscometer (manufactured by Brookfield Engineering Laboratories, Rotor No. 4, 6 rpm, 3 minutes, 25° C.).

Next, under the same condition as above except that the rotation number was changed to 60 rpm, the viscosity was measured, and according to the following formula (5), the thixotropic index (TI) was calculated, and this TI was evaluated according to the following criteria.

[Math. 8]

TI=viscosity at rotation number 6 rpm (mPa·s)/viscosity at rotation number 60 rpm (mPa·s) (5)

A: TI was 6 or more.

B: TI was 4 or more and less than 6.

C: TI was 3 or more and less than 4.

D: TI was less than 3.

### Examples 2 to 7, Reference Example and Comparative Examples 1 to 3

As shown in the following Table 2, any of the cellulose fibers A2 to A7, A′1 and A′2 produced in the manner as above, a commercially-available polyacrylamide (TELCOAT DP, manufactured by Telnite Co., Ltd.), and a commercially-available xanthan gum (XCD Polymer, manufactured by Telnite Co., Ltd.) was used in place of the cellulose fibers A1. In the same manner as in Example 1 except this, the characteristics were evaluated. The results are inclusively shown in the following Table 2.

TABLE 2

| | Example | | | | | | | Reference | Comparative Example | | |
|---|---|---|---|---|---|---|---|---|---|---|---|
| | 1 | 2 | 3 | 4 | 5 | 6 | 7 | Example | 1 | 2 | 3 |
| Gelling Agent | A1 | A2 | A3 | A4 | A5 | A6 | A7 | A′1 | A′2 | polyacrylamide | xanthan gum |
| Viscosity | A | B | B | B | A | A | A | A | D | D | D |
| Degradation | | | | | | | | | | | |
| Gelation | good | good | good | good | good | good | good | poor | poor | poor | poor |
| Environmental | good | good | good | good | good | good | good | good | good | poor | good |
| Load | | | | | | | | | | | |
| Viscosity at 6 rpm | 3850 | 4330 | 4510 | 4780 | 4660 | 5270 | 5830 | 4620 | 200 | 4820 | 3240 |
| (mPa · s) | | | | | | | | | | | |
| TI | A | B | B | B | A | A | A | C | D | D | C |

From the results in the above Table 2, the test liquids of Examples did not show viscosity degradation and showed a suitable gelation with basic aluminum acetate, therefore having a high water-stopping effect and capable of obtaining good result in terms of environmental load. As opposed to these, the test liquid of Reference Example did not show gelation with basic aluminum acetate though not showing viscosity degradation. In the test liquid of Comparative Example 1, the cellulose fibers A′2 did not originating in coniferous trees and therefore did not have a cellulose I-type crystal structure, and accordingly, the test liquid was inferior in terms of viscosity degradation. The polyacrylamide in Comparative Example 2 and xanthan gum in Comparative Example 3 both were inferior in terms of viscosity degradation and did not show gelation with basic aluminum acetate. Further, Comparative Example 2 using polyacrylamide showed poor result also in terms of environmental load.

From the results in the above Table 2, the test liquids of Examples and Reference Example had a higher viscosity at 6 rpm and had a higher TI and were free from viscosity degradation, as compared with the test liquids of Comparative Examples. From this, it is known from the above-mentioned characteristics that, in a liquid hydrocarbon enhanced recovery method (EOR), that is, in a method where an aqueous solution containing a thickener is pressed into a well (pressing-in well) so that the liquid hydrocarbon in the oil reservoir targeted by the well is extruded out into another well (production well) that is connected via the oil reservoir and the liquid hydrocarbon is thereby recovered from the other well, when the test liquid in Examples and Reference Example is used as the thickener, its effect of extruding out the remaining crude oil is high as compared with that in the case where the test liquid of Comparative Examples is used as the thickener. Consequently, in the liquid hydrocarbon enhanced recovery method where the test liquid of Examples and Reference Example is used as the thickener, the liquid hydrocarbon recovery rate can be increased. In addition, the test liquid of Examples has a high TI and can be therefore readily pressed into wells, and as a result, the liquid hydrocarbon enhanced recovery method using the test liquid as a thickener can be readily practiced as compared with any other many methods of enhanced oil recovery method.

In addition, in the liquid hydrocarbon enhanced recovery method (EOR), the above-mentioned advantageous effects can be realized by pressing the solution prepared by nano-dispersing cellulose fibers of conifer-derived pulp, followed by diluting, into wells, and accordingly, it is known that the cellulose fiber nano-dispersion pressing-in device of the present invention specialized in it is advantageous in realizing the above-mentioned advantageous effects. Specifically, the cellulose fiber nano-dispersion pressing-in device of the present invention includes a grinding means for grinding conifer-derived pulp in water, a dilution means for diluting the cellulose fiber-containing liquid obtained in the grinding means and a pressing-in means for pressing the nano-dispersion of the cellulose fiber obtained in the dilution means into a well. In particular, in the cellulose fiber nano-dispersion pressing-in device of the present invention where the grinding means is provided in the vicinity of a well, the cellulose fiber nano-dispersion to be pressed into a well can be prepared at drilling sites and can be directly pressed into a well, and therefore the device can solve problems of microbial contamination of wells and time degradation of the cellulose fiber nano-dispersion, and consequently, the device is extremely useful in obtaining the advantageous effects as in Examples.

### Examples 8 to 12, Comparative Examples 4, 5

As shown in the following Table 3, any of the cellulose fibers A7 produced in the manner as above, a commercially-available polyacrylamide (TELCOAT DP, manufactured by Telnite Co., Ltd.) and a commercially-available xanthan gum (XCD Polymer, manufactured by Telnite Co., Ltd.) was used in place of the cellulose fibers A1 as the gelling agent, and the type of the crosslinking agent <<basic aluminum acetate (A1 acetate), aluminum potassium sulfate anhydride (potash alum), sodium bichromate (Na bichromate), or borax>> as well as the incorporated amount of the gelling agent and the crosslinking agent were changed as shown in the following Table 3. In the same manner as in Example 1 except these, the “gelation” and the “environmental load” were evaluated. The results are inclusively shown in the following Table 3.

TABLE 3

| | | | | | | Comparative | |
|---|---|---|---|---|---|---|---|
| | Example | | | | | Example | |
| | 8 | 9 | 10 | 11 | 12 | 4 | 5 |
| Gelling Agent | A7 | A7 | A7 | A7 | A7 | polyacrylamide | xanthan |
| | | | | | | | gum |
| Concentration of | 0.2 | 1.0 | 0.5 | 0.2 | 1.0 | 0.5 | 1.5 |
| Gelling Agent | | | | | | | |
| (%) | | | | | | | |
| Crosslinking | Al | Al | potash | potash | potash | Na | borax |
| Agent | acetate | acetate | alum | alum | alum | bichromate | |
| Concentration of | 0.1 | 0.5 | 0.2 | 0.1 | 0.5 | 0.2 | 0.5 |
| Crosslinking | | | | | | | |
| Agent (%) | | | | | | | |
| Gelation | good | good | good | good | good | good | good |
| Environmental | good | good | good | good | good | poor | poor |
| Load | | | | | | | |

From the results in the above Table 3, the test liquids of Examples showed a suitable gelation, therefore having a high water-stopping effect and capable of obtaining a good result in terms of environmental load. As opposed to these, in Comparative Example 4 and Comparative Example 5, the samples showed a suitable gelation by the crosslinking agent, sodium bichromate or borax, but as using the crosslinking agent, they resulted in being inferior in terms of environmental load.

It is noted that, in a hydrocarbon production method where an aqueous solution containing a gelling agent is pressed into a well and hydrocarbon is recovered from the well, when the gelling agent and the crosslinking agent in Examples are used, the environmental load is small and the water-stopping effect is high owing to the above-mentioned characteristics, as compared with the case of using the gelling agent and the crosslinking agent in Comparative Examples, and consequently, they can be applied to the hydrocarbon production method as in FIG. 1. In addition, it is noted that, in the condition where water or gas are pressed into the oil reservoir via wells for improving crude oil recovery rate as illustrated in FIG. 2, when the gelling agent and the crosslinking agent in Examples are used, and gels are formed in the prevailing flow channels for the pressed-in fluids to stop the invasion by the fluids so as to change the flow channels for the pressed-in fluids, whereby more oil having remained in the oil reservoir can be recovered from other wells, leading to an enhanced recovery of the hydrocarbon.

In addition, in the hydrocarbon production method illustrated in FIG. 1 and FIG. 2, the above-mentioned advantageous effects can be realized by pressing the solution prepared by nano-dispersing cellulose fibers of conifer-derived pulp, followed by diluting, into wells, and accordingly, it is known that the cellulose fiber nano-dispersion pressing-in device of the present invention specialized in it is advantageous in realizing the above-mentioned advantageous effects. Specifically, the cellulose fiber nano-dispersion pressing-in device of the present invention includes a grinding means for grinding conifer-derived pulp in water, a dilution means for diluting the cellulose fiber-containing liquid obtained in the grinding means and a pressing-in means for pressing the nano-dispersion of the cellulose fiber obtained in the dilution means into a well. In particular, in the cellulose fiber nano-dispersion pressing-in device of the present invention where the grinding means is provided in the vicinity of a well, the cellulose fiber nano-dispersion to be pressed into a well can be prepared at drilling sites and can be directly pressed into a well, and therefore the device can solve problems of microbial contamination of wells and time degradation of the cellulose fiber nano-dispersion, and consequently, the device is extremely useful in obtaining the advantageous effects as in Examples.

### Examples 13 to 23 and Comparative Examples 6 to 14

### Preparation of Cellulose Fibers B1 (for Examples)

In 4950 g of water was dispersed 50 g of needle bleached kraft pulp (NBKP) to prepare a dispersion having a pulp concentration of 1% by mass. The dispersion was processed 30 times with CERENDIPITOR MKCA6-3 (manufactured by Masuko Sangyo Co., Ltd.) to prepare cellulose fibers B1.

### [Preparation of Cellulose Fibers B2 (for Examples)]

Into a mixed liquid of 435 g of isopropanol (IPA), 65 g of water and 9.9 g of NaOH was put 100 g of coniferous pulp, followed by stirring at 30° C. for 1 hour. To the slurry was added 23.0 g of 50% monochloroacetic acid, followed by heating up to 70° C. and a reaction for 1.5 hours. The resultant reaction product was washed with 80% methanol, then substituted with methanol and dried to give carboxymethylated cellulose fibers. Next, pure water was added to the cellulose fibers to dilute into 2%, followed by processing once with a high-pressure homogenizer (H11 manufactured by Sanwa Engineering Co., Ltd.) under a pressure of 100 MPa to prepare cellulose fibers B2.

### [Preparation of Cellulose Fibers B3 (for Examples)]

To 2 g of coniferous pulp were added 150 ml of water, 0.25 g of sodium bromide and 0.025 g of TEMPO, followed by fully stirring to disperse. An aqueous solution of 13 wt % sodium hypochlorite (co-oxidizing agent) was then added thereto so that the amount of sodium hypochlorite per 1.0 g of the pulp could be 12 mmol/g, and the reaction was started. With the reaction going on, the pH lowered and therefore an aqueous solution of 0.5 N sodium hydroxide was added dropwise so as to keep the pH at 10 to 11, and the reaction was continued until no pH change could be detected (reaction time: 120 minutes). After the completion of the reaction, 0.1 N hydrochloric acid was added for neutralization, followed by purification by repeated filtration and washing with water to thereby give cellulose fibers whose fiber surfaces were oxidized. Next, pure water was added to the cellulose fibers to dilute them into 2%, followed by processing once with a high-pressure homogenizer (H11 manufactured by Sanwa Engineering Co., Ltd.) under a pressure of 100 MPa to prepare cellulose fibers B3.

### [Preparation of Cellulose Fibers B′1 (for Comparative Examples)]

In 4950 g of water was dispersed 50 g of needle bleached kraft pulp (NBKP) to prepare a dispersion having a pulp concentration of 1% by mass. The dispersion was processed 10 times with CERENDIPITOR MKCA6-3 (manufactured by Masuko Sangyo Co., Ltd.) to prepare cellulose fibers B′ 1.

### [Preparation of Cellulose Fibers B′2 (for Comparative Examples)]

Cellulose B′2 was prepared according to preparation of the cellulose fibers B3 except that regenerated cellulose was used in place of the coniferous pulp as a raw material and that the addition amount of the aqueous sodium hypochlorite solution was changed to 27.0 mmol/g per 1.0 g of the regenerated cellulose.

The cellulose fibers B1 to B3, B′1 and B′2 prepared in the manner as above were evaluated according to the above-mentioned criteria, as shown in the following Table 4. The results are as shown below.

TABLE 4

| | for Examples | | | for Comparative Examples | |
|---|---|---|---|---|---|
| | B1 | B2 | B3 | B′1 | B′2 |
| Crystal | present | present | present | present | absent |
| Structure | | | | | |
| Number- | 250 | 56 | 11 | 1100 | unmeasurable |
| Average Fiber | | | | | (not more |
| Diameter [nm] | | | | | than 1) |
| Aspect Ratio | 56 | 140 | 242 | 35 | unmeasurable |

From the results in the above Table 4, the cellulose fibers B1 to B3 for Examples all had a number-average fiber diameter falling within a range of 2 to 500 nm and had a cellulose I-type crystal structure. As opposed to these, the number-average fiber diameter of the cellulose fibers B′1 for Comparative Examples was over a nano-level. The cellulose fibers B′2 did not have a cellulose I-type crystal structure, and the number-average fiber diameter thereof was too small and was therefore unmeasurable (not more than 1 nm).

### Example 13

### Gelation of Cellulose Fibers B1 by Heating

The cellulose fibers B1 were diluted with distilled water to have a solid content of 0.6, and dispersed with a homomixer at 8,000 rpm for 10 minutes. This was transferred into a PTFE crucible (inner diameter 45 mm, height 60 mm) so that the depth thereof is 50 mm, followed by sealing up with a stainless pressure-tight vessel. After sealed up, by using a constant-temperature bath, this was heated at 130° C. for 24 hours for gelation. After 24 hours, it was taken out of the constant-temperature bath, and statically left at room temperature for 5 hours. Gelation or not was judged according to the following method. As a result of judgment, the cellulose fibers B1 gelled under the above-mentioned condition.

### [Method for Judgment for Gelation]

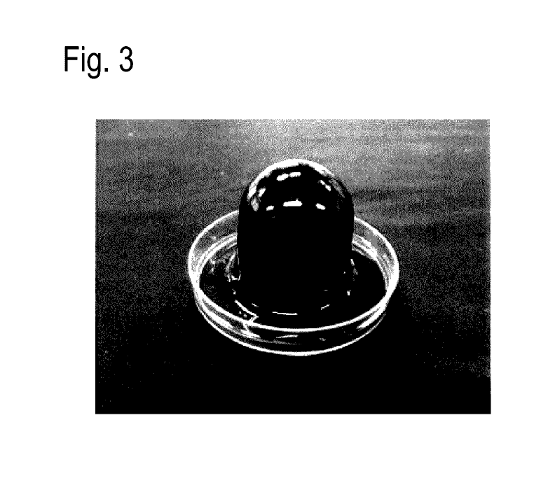

A PTFE vessel was covered with a plastic petri dish, and gently inverted. Subsequently, the PTFE crucible was gently drawn up, and the contents were taken out onto the plastic petri dish. In 1 minute after taking out, the height of the contents on the petri dish was measured. When the original shape (height 50 mm) was kept through gelation and the height was 30 mm or more, like the sample picture shown in FIG. 3, the sample was judged as “gelled”, but when the height was less than it, the sample was judged as “not gelled”.

### Examples 14, 15

### Gelation of Cellulose Fibers B2 and B3 by Heating

Tests were carried out according to the same method as in Example 13 except that the cellulose fibers B2 or B3 were used in place of the cellulose fibers B1. As a result of judgment, the cellulose fibers B2 and B3 both gelled.

### Comparative Examples 6, 7

### Gelation of Cellulose Fibers B′1 and B′2 by Heating

Tests were carried out according to the same method as in Example 13 except that the cellulose fibers B′1 or B′2 were used in place of the cellulose fibers B1. As a result of judgment, the cellulose fibers B′1 and B′2 both did not gel and when taken out of the PTFE crucible, these were fluid and did not keep the original form thereof

Here, the results of Examples 13 to 15 and Comparative Examples 6 and 7 are inclusively shown in Table 5.

TABLE 5

| | | | | Compar- | Compar- |
|---|---|---|---|---|---|
| | | | | ative | ative |
| | Example | Example | Example | Example | Example |
| | 13 | 14 | 15 | 6 | 7 |
| Cellulose | B1 | B2 | B3 | B′1 | B′2 |
| Fibers | | | | | |
| Gelation | gelled | gelled | gelled | not | not |
| or not | | | | gelled | gelled |

### Examples 16, 17

### Gelation (1) of Cellulose Fibers B2 and B3 with Crosslinking Agent

The cellulose fiber B2 or B3 were diluted with distilled water to have a solid content of 0.6%, and dispersed at 8,000 rpm for 10 minutes by using a homomixer. Basic aluminum acetate was added thereto in an amount of 0.2% relative to the total amount, and further dispersed at 8,000 rpm for 10 minutes by using a homomixer. This was transferred into a 100-ml beaker so that the depth thereof is 50 mm, and while kept wrapped, this was left statically for 24 hours for gelation. After 24 hours, the gelation or not was judged according to the following method. As a result of judgment, the cellulose fibers B2 and B3 gelled under the above-mentioned condition.

### [Method for Judgment for Gelation]

A 100-ml beaker was covered with a plastic petri dish, and gently inverted. Subsequently, the beaker was gently drawn up, and the contents were taken out onto the plastic petri dish. In 1 minute after taking out, the height of the contents on the petri dish was measured. When the original shape (height 50 mm) was kept through gelation and the height was 30 mm or more, the sample was judged as “gelled”, but when the height was less than it, the sample was judged as “not gelled”.

### Comparative Examples 8, 9

### Gelation of Cellulose Fibers B′1 and B′2 with Crosslinking Agent

Tests were carried out according to the same method as in Example 16 except that the cellulose fiber B′1 or B′2 were used in place of the cellulose fibers B2. As a result of judgment, the cellulose fibers B′1 and B′2 both did not gel and when taken out of the beaker, these were fluid and did not keep the original form thereof

### Examples 18, 19

### Gelation (2) of Cellulose Fibers B2 and B3 with Crosslinking Agent

The cellulose fiber B2 or B3 were diluted with distilled water to have a solid content of 0.6%, and dispersed at 8,000 rpm for 10 minutes by using a homomixer. This was transferred into a 100-ml beaker so that the depth thereof is 50 mm, and an aqueous solution of 1.0 M aluminum chloride was gently added thereto in an amount of 2.0% relative to the total amount. Subsequently, while kept wrapped, this was left statically for 24 hours for gelation. After 24 hours, the gelation or not was judged according to the following method. As a result of judgment, the cellulose fibers B2 and B3 gelled under the above-mentioned condition.

### [Method for Judgment for Gelation]

A 100-ml beaker was covered with a plastic petri dish, and gently inverted. Subsequently, the beaker was gently drawn up, and the contents were taken out onto the plastic petri dish. In 1 minute after taking out, the height of the contents on the petri dish was measured. When the original shape (height 50 mm) was kept through gelation and the height was 30 mm or more, the sample was judged as “gelled”, but when the height was less than it, the sample was judged as “not gelled”.

### Comparative Examples 10, 11

### Gelation of Cellulose Fibers B′1 and B′2 with Crosslinking Agent

Tests were carried out according to the same method as in Example 18 except that the cellulose fiber B′1 or B′2 were used in place of the cellulose fibers B2. As a result of judgment, the cellulose fibers B′1 and B′2 both did not gel and when taken out of the beaker, these were fluid and did not keep the original form thereof

### Example 20

### Polymer EOR Test by Using Pseudo Oil Reservoir

### <Preparation of Pseudo Oil Reservoir>

Two fluororesin-made tubes each having a length of 400 mm (inner diameter 15 mm) were connected on the same side via a Y-shaped connector, and to the opposite side thereof, a third fluororesin tube having a length of 50 mm were fixed in such that a liquid could be pressed thereinto from a syringe. Sea sand (manufactured by Nacalai Tesque Inc.) was stuffed into one fluororesin-made tube having a length of 400 mm, and finally absorbent cotton was stuffed thereinto, and the tip thereof was pinched with a pinchcock to have a gap of about 5 mm whereby the sea sand inside it was sealed up. The side of the Y-shaped connector on which the two tubes were connected was referred to as a pseudo oil reservoir side, in which one side packed with sea sand was referred to as a low-penetration pseudo oil reservoir side and the other side was referred to as a high-penetration pseudo oil reservoir side. The opposite side of the Y-shaped connector was referred to as a pressing-in side.

### <Water Flooding Test for Pseudo Oil Reservoir>

First, the tip of the high-penetration pseudo oil reservoir was folded and sealed up airtightly, and in that condition, silicone oil was pressed in from the pressing-in side by using a syringe pump. Next, the tip of the high-penetration pseudo oil reservoir was opened and, while the tip of the low-penetration pseudo oil reservoir was left folded and sealed up, silicone oil was pressed in from the pressing-in side by using a syringe pump. In that manner, both the pseudo oil reservoirs were filled with silicone oil. Subsequently, while both the pseudo oil reservoirs were kept opened at the tip thereof, brine (aqueous 3% sodium chloride solution) was pressed in from the pressing-in side by using a syringe pump. As a result, silicone oil and brine flowed out only from the high-penetration pseudo oil reservoir side with no sea sand sealed up therein.

<Polymer EOR Test with Cellulose Nanofibers for Pseudo Oil Reservoir>

Distilled water was added to the cellulose fibers B3 having a solid concentration of 2.0%, followed by stirring at 8,000 rpm for 10 minutes with a homomixer. Accordingly, an aqueous dispersion of 0.2% cellulose fibers B3 was prepared. The aqueous dispersion of 0.2% cellulose fibers B3 was pressed into the pseudo oil reservoir from the pressing-side by using a syringe pump. As a result, with brine, silicone oil and brine did not flow out only from the high-penetration pseudo oil reservoir, but in the case of the aqueous dispersion of cellulose fibers, flow-out of silicone oil and brine also from the low-penetration pseudo oil reservoir side in which sands of sea are filled was confirmed.

### Example 21

### Water-Stopping Test by Heated Gel

### <Gelation by Sealing Up and Heating of Pseudo Oil Reservoir>

In the same manner as in Example 20, the pseudo oil reservoir was filled with silicone oil, and then, from the end of the high-penetration pseudo oil reservoir, 10 ml of an aqueous dispersion of 0.2% cellulose fibers B3 was pressed in by using a syringe pump. Subsequently, all the fluororesin tubes were folded and sealed up airtightly. Next, the sealed-up pseudo oil reservoir was sunk in a glass vessel filled with distilled water, and this was heated in an autoclave at 130° C. for 24 hours at 3 atmospheres, and then gradually cooled taking 5 hours.

### <Water-Stopping Performance Evaluation Test>

All the fluororesin tubes of the pseudo oil reservoir were opened, and then, by using a syringe pump, brine (aqueous 3% sodium chloride solution) was pressed in from the pressing-in side. As a result, in the high-penetration pseudo oil reservoir, the cellulose fibers gelled and prevented brine from flowing out, and therefore, silicone oil and brine flowed out only from the low-penetration pseudo oil reservoir.

### Comparative Example 12

A test was carried out in the same manner as in Example 21 except that B′2 was used in place of the cellulose fibers B3. However, the cellulose fibers B′2 did not gel, and silicone oil and brine flowed out from the high-penetration pseudo oil reservoir side.

### Example 22

### Water-Stopping Test (1) by Crosslinked Gel

### <Liquid Preparation>

Distilled water was added to the cellulose fibers B3 having a solid concentration of 2.0%, followed by stirring at 8,000 rpm for 10 minutes by using a homomixer. Further, basic aluminum acetate was added thereto in an amount of 0.1% relative to the total amount, followed by stirring at 8,000 rpm for 10 minutes by using a homomixer. This is an aqueous dispersion of crosslinked gel cellulose.

### <Gelation by Sealing Up and Heating of Pseudo Oil Reservoir>

In the same manner as in Example 20, the pseudo oil reservoir was filled with silicone oil, and then, from the end of the high-penetration pseudo oil reservoir, 10 ml of the aqueous dispersion of crosslinked gel cellulose was pressed in by using a syringe pump. Subsequently, all the fluororesin tubes were folded and sealed up airtightly. Under the condition, this was statically left as such for 24 hours, and the cellulose fibers were made to gel by crosslinking.

### <Water-Stopping Performance Evaluation Test>

All the fluororesin tubes of the pseudo oil reservoir were opened, and then, by using a syringe pump, brine (aqueous 3% sodium chloride solution) was pressed in from the pressing-in side. As a result, in the high-penetration pseudo oil reservoir, the cellulose fibers gelled and prevented brine from flowing out, and therefore, silicone oil and brine flowed out only from the low-penetration pseudo oil reservoir.

### Comparative Example 13

A test was carried out in the same manner as in Example 22 except that B′2 was used in place of the cellulose fibers B3. However, the cellulose fibers B′2 did not gel, and silicone oil and brine flowed out from the high-penetration pseudo oil reservoir side.

### Example 23

### Water-Stopping Test (2) by Crosslinked Gel

### <Liquid Preparation>

Distilled water was added to the cellulose fibers B3 having a solid concentration of 2.0%, followed by stirring at 8,000 rpm for 10 minutes by using a homomixer to prepare an aqueous dispersion of 0.2% cellulose fibers.

### <Gelation by Sealing Up and Heating of Pseudo Oil Reservoir>

In the same manner as in Example 20, the pseudo oil reservoir was filled with silicone oil, and then, from the end of the high-penetration pseudo oil reservoir, 10 ml of the aqueous dispersion of 0.2% cellulose fibers was pressed in by using a syringe pump. Subsequently, 0.2 ml of an aqueous solution of 1.0 M aluminum chloride was pressed in. Next, all the fluororesin tubes were folded and sealed up airtightly. Under the condition, this was statically left as such for 24 hours, and the cellulose fibers were made to gel by crosslinking.

### <Water-Stopping Performance Evaluation Test>

All the fluororesin tubes of the pseudo oil reservoir were opened, and then, by using a syringe pump, brine (aqueous 3% sodium chloride solution) was pressed in from the pressing-in side. As a result, in the high-penetration pseudo oil reservoir, the cellulose fibers gelled and prevented brine from flowing out, and therefore, silicone oil and brine flowed out only from the low-penetration pseudo oil reservoir.

### Comparative Example 14

A test was carried out in the same manner as in Example 23 except that B′2 was used in place of the cellulose fibers B3. However, the cellulose fibers B′2 did not gel, and silicone oil and brine flowed out from the high-penetration pseudo oil reservoir side.

The above Examples are to demonstrate concrete embodiments of the present invention, but the above Examples are mere exemplifications and should not be limitatively interpreted. Various modifications obvious to anyone skilled in the art are intended to fall within the scope of the present invention.

### INDUSTRIAL APPLICABILITY

The cellulose fiber nano-dispersion pressing-in device of the present invention can carry out stable water-stopping operation without giving any load to the environment. In particular, the cellulose fiber nano-dispersion pressing-in device of the present invention is favorably used in a production method for hydrocarbons such as crude oil, gas, etc. The hydrocarbon production method of the present invention may be applied to wells in which the ratio of water to production fluid has increased, thereby reducing the labor and cost for accompanying water treatment and improving the crude oil/gas recovery rate. In addition, from the viewpoint of improving the sweeping efficiency for oil through pressing-in of water and gas, the hydrocarbon production method of the present invention is extremely effective.

### REFERENCE SIGNS LIST

1 Tubing
2 Casing
3 High-Pressure Homogenizer
4, 5 Stirrer
6 Separation Tank
7 Desalting Machine
8 Packer
9 Water Tank
p1 to p4 Pump
a1 to a5, b1 to b6 Valve

1. A cellulose fiber nano-dispersion pressing-in device for pressing a liquid comprising a cellulose fiber of a conifer-derived pulp being nano-dispersed therein, into a stratum, comprising a grinding unit that grinds the conifer-derived pulp in water, a dilution unit that dilutes a cellulose fiber-containing liquid obtained in the grinding unit and a pressing-in unit that presses a nano-dispersion of the cellulose fiber obtained in the dilution unit into a well.

2. The cellulose fiber nano-dispersion pressing-in device according to claim 1, wherein the grinding unit is provided in the vicinity of the well in the earth's surface.

3. A cellulose fiber nano-dispersion pressing-in method, comprising using the cellulose fiber nano-dispersion pressing-in device according to claim 1 to thereby press a nano-dispersion of a cellulose fiber into an underground pervious stratum around a well.

4. A hydrocarbon production method, comprising a cellulose fiber nano-dispersion pressing-in step of pressing a cellulose fiber nano-dispersion prepared by grinding a conifer-derived pulp in water and dispersing it in a liquid, into an underground pervious stratum through a well.

5. The hydrocarbon production method according to claim 4, comprising the cellulose fiber nano-dispersion pressing-in step, a blocking step of blocking up a pressing-in flow channel thereof and a production step of recovering a hydrocarbon from the well after opening the blocking of the pressing-in flow channel.

6. The hydrocarbon production method according to claim 4, wherein, as the cellulose fiber nano-dispersion, one where a hydroxyl group on a surface of the cellulose fiber in the dispersion has been chemically modified is used.

7. The hydrocarbon production method according to claim 6, further comprising a polyvalent metal salt-containing aqueous solution pressing-in step of pressing a polyvalent metal salt-containing aqueous solution into the well before the cellulose fiber nano-dispersion pressing-in step and/or after the cellulose fiber nano-dispersion pressing-in step.

8. The hydrocarbon production method according to claim 6, wherein the cellulose fiber nano-dispersion comprises a polyvalent metal salt.

9. The hydrocarbon production method according to claim 5, wherein, after the cellulose fiber nano-dispersion pressing-in step, an aqueous solution containing no cellulose fiber is pressed in and then the blocking step is carried out.

10. The hydrocarbon production method according to claim 4, wherein a well (pressing-in well) where the cellulose fiber nano-dispersion pressing-in step is carried out and a well (production well) where a hydrocarbon is recovered are different wells.

11. The hydrocarbon production method according to claim 4, wherein a clear water is pressed into the well before the cellulose fiber nano-dispersion pressing-in step.

12. A cellulose fiber nano-dispersion pressing-in method, comprising using the cellulose fiber nano-dispersion pressing-in device according to claim 2 to thereby press a nano-dispersion of a cellulose fiber into an underground pervious stratum around a well.

13. The hydrocarbon production method according to claim 5, wherein, as the cellulose fiber nano-dispersion, one where a hydroxyl group on a surface of the cellulose fiber in the dispersion has been chemically modified is used.
